(19) United States
(12) Patent Application Publication
(10) Pub. No.: US 2013/0177761 A1
(43) Pub. Date: Jul. 11, 2013

(54) SURFACE PROTECTION FILM

(71) Applicants: Yoichiro Kimura, Sanbu-gun (JP); Tomoyuki Kitajima, Sanbu-gun (JP)

(72) Inventors: Yoichiro Kimura, Sanbu-gun (JP); Tomoyuki Kitajima, Sanbu-gun (JP)

(73) Assignee: IDEMITSU UNITECH CO., LTD., Tokyo (JP)

(21) Appl. No.: 13/824,406

(22) PCT Filed: Oct. 4, 2011
(86) PCT No.: PCT/JP2011/072846

§ 371 Date: Mar. 18, 2013

(30) Foreign Application Priority Data
Oct. 5, 2010 (JP) 2010-225827

(51) Int. Cl. C09J 7/02

(52) U.S. Cl. CPC C09J 7/0271
USPC 428/336; 428/343; 428/355 BL

(57) ABSTRACT

A surface protective film includes a polyolefin base material layer and an adhesive layer. The adhesive layer has hardness (Martens hardness) in a range of 1 N/mm² to 2.5 N/mm² and loop tack strength in a range of 0.02 N/25 mm to 0.1 N/25 mm. Accordingly, the surface protective film, even in a form of a rolled product, is easily wound off from a surface of the base material, and can obtain a sufficient adhesive strength to an adherend (e.g., a prism sheet) having a projection on its surface.

### TECHNICAL FIELD

The present invention relates to a surface protective film, more specifically, to a surface protective film temporarily attached to a metal plate, a glass plate, a synthetic resin plate and the like.

### BACKGROUND ART

There has been known a surface protective film that is temporarily attached to a surface of a metal plate, a glass plate or a synthetic resin plate for preventing the surface from being damaged or being attached with dusts and the like.

For instance, Patent Literature 1 discloses a surface protective film formed by co-extruding a polyolefin resin base material and an adhesive layer, in which the adhesive layer is formed by a composition containing a block copolymer represented by a general formula A-B-A (A is a styrene polymer block and B is a copolymer block of ethylene and butylene) and a tackifier resin. Moreover, Patent Literature 2 discloses a surface protective film formed by laminating an adhesive layer on one surface of a base material film made of polyolefin, in which the adhesive layer contains: a block copolymer represented by a general formula A-B-A or A-B (A is a styrene polymer block and B is a butadiene polymer block, an isoprene polymer block or a hydrogenated polymer block thereof); a tackifier resin; and a polyolefin resin. Further, Patent Literature 3 discloses a surface protective film formed by laminating an adhesive layer on one surface of a support body, in which the adhesive layer contains a composition containing a triblock copolymer formed by a single intermediate polymer block induced from a conjugated diene compound and two terminal polymer blocks derived from a vinyl aromatic compound.

### CITATION LIST

### Patent Literature(s)

Patent Literature 1: JP-A-61-103975
Patent Literature 2: Japanese Patent No. 2713519
Patent Literature 3: JP-A-2000-80336

### SUMMARY OF THE INVENTION

### Problems to be Solved by the Invention

However, when such a surface protective film as disclosed in Patent Document 1 is rolled up to form a rolled product and stored or transferred, an adhesive layer attached around a rear surface of a base material may be excessively adhered to the base material. Consequently, the surface protective film is not easily wound off from the rolled product, thereby reducing efficiency in attachment of the surface protective film to a surface of an adherend. When the surface protective film is forcefully wound off, the base material may be partially stretched to be deformed, so that the surface protective film may not function in use.

In order to solve these problems, a mold releasing agent is coated or mold releasing treatment such as corona treatment is applied on the rear surface of the base material. However, in use of a mold releasing agent, a particular kind of mold releasing agent that firmly adheres to the base material but does not adhere to the adhesive layer is required. When the mold releasing agent seeps into the adhesive layer, adhesive force of the surface protective film to the adherend may be reduced. Further, due to a complicated process for applying the mold releasing agent or conducting the mold releasing treatment such as corona treatment, manufacturing cost of the surface protective film may be increased.

In order to solve the above problem, a method for controlling adhesive strength has also been typically used. Such a method for controlling adhesive strength is exemplified by a method disclosed in, for instance, Patent Literature 2, in which an amount of the tackifier is adjusted to control adhesive strength. In Patent Literature 3, adhesive strength is controlled by adjusting an amount of diblock in a styrene polymer block.

However, in the method of Patent Literature 2, an adjustable range of the mixed amount is too narrow to achieve both adhesive strength and an unwinding property from the rolled product. In the method of Patent Literature 3, an increase in the amount of diblock, which can increase the adhesive strength, makes the film so sticky as to be difficult to wind off from the rolled product.

Moreover, in the case of an adherend having projections on its surface (e.g., a prism sheet), in order to increase adhesive strength of the adhesive layer to such a rough surface, it is necessary to decrease hardness of the adhesive layer (e.g., to increase a contact area of the adhesive layer to the rough surface) or to increase loop tack strength of the adhesive layer (i.e., to increase stickiness). However, in these methods, because of a large increase in the adhesive strength to a base material surface that is less rough than the prism sheet, the unwinding property becomes deteriorated. Accordingly, since it is necessary to roughen the rear surface of the base material layer in order to improve the unwinding property, it becomes difficult to form a transparent surface protective film, which hinders a practical use of the film.

An object of the invention is to provide a surface protective film easily wound off from a rolled product while keeping a sufficient adhesive strength.

### Means for Solving the Problems

In order to solve the above problems, the invention provides the following surface protective film.

(1) According to an aspect of the invention, a surface protective film includes a polyolefin base material layer and an adhesive layer, in which the adhesive layer has hardness (Martens hardness) in a range of 1N/mm² to 2.5 N/mm² and loop tack strength in a range of 0.02 N/25 mm to 0.1N/25 mm.
(2) In the surface protective film according to the above aspect of the invention, the adhesive layer includes: a vinyl-polyisoprene-block-containing styrene elastomer; a polyolefin; and a tackifier.
(3) In the surface protective film according to the above aspect of the invention, the styrene elastomer has a styrene content in a range of 5 mass % to 30 mass %.
(4) In the surface protective film according to the above aspect of the invention, the styrene elastomer has a triblock copolymer content in a range of 80 mass % or more.
(5) In the surface protective film according to the above aspect of the invention, the styrene elastomer has a glass transition temperature in a range of −60 degrees C. to 20 degrees C.
(6) In the surface protective film according to the above aspect of the invention, the adhesive layer has a thickness of 25 μm or less.
(7) In the surface protective film according to the above aspect of the invention, the base material layer has an outer haze of 20% or less.
(8) In the surface protective film according to the above aspect of the invention, the adhesive layer is laminated by co-extrusion.

The above aspect of the invention can provide a surface protective film easily wound off from a rolled product while keeping a sufficient adhesive strength to an adherend having a projection on its surface, without an excessively firm adhesion between the adhesive layer and the base material layer of the rolled product even when the base material layer for forming the surface protective layer has a smooth rear surface. Accordingly, the surface protective film according to the above aspect of the invention is useful as a surface protective film, which is delivered in a form of a rolled product, for an adherend having a projection on its surface (e.g., a prism sheet).

### BRIEF DESCRIPTION OF DRAWING

FIG. 1 is a schematic diagram showing a test of measuring loop tack strength in Examples.

### DESCRIPTION OF EMBODIMENT(S)

A surface protective film in an exemplary embodiment of the invention includes a base material layer and an adhesive layer. The adhesive layer has hardness (Martens hardness) in a range of 1N/mm² to 2.5 N/mm² and loop tack strength in a range of 0.02 N/25 mm to 0.1N/25 mm. The exemplary embodiment of the invention will be described below.

Any base material layer is usable as long as it is a sheet or film commonly used as a support of a surface protective film, favorable examples of which include a film formed of polyolefin materials or the like.

Examples of the polyolefin materials usable for the base material layer include low-density polyethylene, medium-density polyethylene, high-density polyethylene, linear low-density polyethylene, ethylene-a-olefin copolymer, ethylene-vinyl-acetate copolymer, ethylene-ethyl acrylate copolymer, ethylene-methyl methacrylate copolymer, ethylene-n-butyl acrylate copolymer, and polypropylene (homopolymer, random copolymer, block copolymer). The polyolefin materials may be used alone or any combination of the polyolefin materials may be used as a mixture or a composition. Especially, block copolymer polypropylene (occasionally abbreviated as BPP) is preferable as a material for the base material layer. A surface of the base material layer is roughened with use of BPP and thus the unwinding property is further enhanced while tearing strength and impact strength are improved.

Additives such as a pigment, an antioxidant, a stabilizer and an ultraviolet absorber may be added to the base material layer as needed.

The base material layer is not limited to one formed of a single layer, but may be formed of a plurality of layers. A total thickness of the base material layer formed of a single layer or a plurality of layers is, for instance, in a range of 20 μm to 100 μm, preferably in a range of 30 μm to 80 μm.

A film having an outer haze of 20% or less is usable as the base material layer of the exemplary embodiment. A small outer haze generally means a smooth surface, which contributes to transparency of the base material surface and, further, of the surface protective film. However, in a typical surface protective film, it is necessary to increase roughness of the surface of the base material layer in consideration of the unwinding property from the rolled product, so that transparency of the base material layer and, further, of the surface protective film has been ignored. In the exemplary embodiment, with the hardness and the loop tack strength of the adhesive layer set within a predetermined range as described later, the surface protective film can exhibit an excellent unwinding property even in a form of the rolled product including the base material layer formed by a transparent film having the outer haze of 20% or less.

It should be noted that the outer haze of the base material layer is measurable in accordance with, for instance, JIS K 7105.

The adhesive layer of the exemplary embodiment is formed of a material having hardness in a range of 1N/mm² to 2.5 N/mm² and loop tack strength in a range of 0.02 N/25 mm to 0.1N/25 mm.

It is found in the exemplary embodiment that, by adjusting the hardness and the loop tack strength of the adhesive layer so as to fall within the above range based on a finding that the contact area between the adhesive layer and the rough adherend depends on the hardness of the adhesive layer and that the adhesive strength between the adhesive layer and the adherend depends on a size of roughness of the adherend, the adhesive layer is favorably adhered on the adherend having a relatively large roughness such as a prism sheet and the adhesive layer has adhesive force easily peelable from an adherend having roughness relatively smaller (e.g., the rear surface of the base material layer) than the roughness of the prism sheet. In other words, with the adhesive layer of the exemplary embodiment, both a sufficient adhesive strength required for the surface protective film and a favorable unwinding property required for the surface protective film in a form of a rolled product are obtained.

A material for obtaining the above-described hardness and loop tack strength is preferably an elastomer. It is more preferable that a tackifier and polyolefins are mixed into the elastomer in use.

As the elastomer, a vinyl-polyisoprene-block-containing styrene elastomer is particularly preferable. The most preferable material for the adhesive layer in the exemplary embodiment is a mixture of the vinyl-polyisoprene-block-containing styrene elastomer, a polyolefin and a tackifier.

The vinyl-polyisoprene-block-containing styrene elastomer contained in the adhesive layer is, for instance, a block copolymer represented by a general formula (1) or (2).

A-B-A (1)

A-B (2)

In the general formulae (1) and (2), A is a styrene block and B is a non-hydrogenated vinyl-polyisoprene block or hydrogenated vinyl-polyisoprene block represented by a general formula (3) below. The styrene elastomer contains an uncoupled styrene block and an uncoupled hydrogenated or non-hydrogenated vinyl-polyisoprene block.

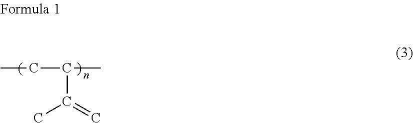

In the vinyl-polyisoprene-block-containing styrene elastomer, the styrene content is in a range of 5 mass % to 30 mass %, preferably in a range of 10 mass % to 25 mass %. When the styrene content is less than 5 mass %, the hardness is low and the adhesive strength is too high. Thus, adhesive deposits may be left on the adherend after peeling. Especially, adhesive deposits are easily left on an adherend having a projection on its surface (e.g., a prism sheet). When the styrene content exceeds 30 mass %, the hardness is too high and thus the adhesive strength to the adherend is weak, so that the surface protective film may unfavorably be peeled off. Especially, the surface protective film is easily peeled off from an adherend having a projection on its surface (e.g., a prism sheet).

Here, the styrene content means a styrene block content relative to the total amount of the vinyl-polyisoprene-block-containing styrene elastomer.

The styrene content is calculated by, for instance, the following method.

A block copolymer composition contained in the adhesive layer of the surface protective film is dissolved in a small amount of hexane and, then, an excessive amount of acetone is added thereto, so that the composition is separated into acetone-insoluble components and acetone-soluble components. The insoluble components are measured by an NMR (nuclear magnetic resonance spectrum method) so as to calculate the styrene content from an integral intensity ratio of spectrum.

The block copolymer represented by the general formula (I) is also referred to as a triblock copolymer. The triblock copolymer content is preferably 80 mass % or more relative to the styrene elastomer, more preferably 90 mass % or more. When the triblock copolymer content is less than 80 mass %, the adhesive strength to the adherend is sometimes too high and thus adhesive deposits may be left after peeling. Also, since the adhesive strength to the rear surface of the base material layer is increased, the unwinding property from the rolled product may be reduced.

The triblock copolymer content is calculated by, for instance, the following method.

The block copolymer composition contained in the adhesive layer of the protective film is dissolved in tetrahydrofuran (TFH). Two columns for liquid chromatography of GS5000H and two columns for liquid chromatography of G4000H (four columns in total) manufactured by Tosoh Corporation are connected in series. High-performance liquid chromatography is performed at a temperature of 40 degrees C. and a flow rate of 1 m/min by using THF for a mobile phase. From the obtained chart, a coupling component, i.e., a peak area corresponding to a triblock copolymer, is obtained. A percentage of the peak area relative to an entire peak area is defined as the triblock copolymer content.

The glass transition temperature of the vinyl-polyisoprene-block-containing styrene elastomer is in a range of −60 degrees C. to 20 degrees. When the glass transition temperature of the vinyl-polyisoprene-block-containing styrene elastomer is less than −60 degrees C., the adhesive strength is not easily expressed in a typical usable temperature area (for instance, −20 degrees C. to 40 degrees C.) of the surface protective film and thus the surface protective film may be peeled off from the adherend. Especially, the surface protective film is easily peeled off from an adherend having a projection on its surface (e.g., a prism sheet).

The glass transition temperature is calculated by, for instance, the following method.

The block copolymer composition contained in the adhesive layer of the protective film is dissolved in a small amount of hexane and then an excessive amount of acetone is added thereto, so that the composition is separated into acetone-insoluble components and acetone-soluble components. The temperature of the insoluble components is raised from a room temperature at a ratio of 20° C./min using a differential scanning calorimeter, and calorific value is measured to depict an endothermic curved line. Two extended lines are added to the endothermic curved line. Then, the glass transition temperature is obtained from an intersection point of a half straight line between the extended lines and the endothermic curved line.

The vinyl-polyisoprene block content is calculated by, for instance, the following method.

A material pellet for the adhesive layer is dissolved in heavy chloroform and, then, measurement by the NMR (nuclear magnetic resonance spectrum method) is performed to calculate the vinyl-polyisoprene block content from an integral intensity ratio of spectrum.

It does not matter whether or not the vinyl-polyisoprene-block-containing styrene elastomer is hydrogenated.

Examples of the polyolefin used for the adhesive layer include low-density polyethylene, medium-density polyethylene, high-density polyethylene, linear low-density polyethylene, ethylene-a-olefin copolymer, ethylene-vinyl-acetate copolymer, ethylene-ethyl acrylate copolymer, ethylene-methyl methacrylate copolymer, ethylene-n-butyl acrylate copolymer, and polypropylene (homopolymer, random copolymer, block copolymer). Among the above-described polyolefins, polypropylene is preferable as a material for the adhesive layer. Polypropylene is compatible with a styrene elastomer including a non-hydrogenated or hydrogenated vinyl-polyisoprene block and has an excellent heat resistance. In addition, polypropylene does not easily cause an adherend to be contaminated by bleed.

One polyolefin or a combination of two or more polyolefins may be used.

A ratio of polyolefin(s) contained in the adhesive layer is favorably in a range of 1 part by mass to 10 parts by mass relative to 100 parts by mass of the vinyl-polyisoprene-block-containing styrene elastomer. When the polyolefin content is less than 1 part by mass, the adhesive strength of the adhesive layer to the adherend becomes high and thus adhesive deposits may be left after peeling. On the other hand, when the polyolefin content exceeds 10 parts by mass, the hardness of the adhesive layer becomes high, so that the adhesive strength of the adhesive layer to, for instance, an adherend having a projection is weakened, so that the adhesive layer may be peeled off. However, when the tackifier content is increased in order to enhance the adhesive strength, the unwinding property from the rolled product may be lowered.

As the tackifier contained in the adhesive layer, a resin selectively compatible with a hydrogenated or non-hydrogenated vinyl-polyisoprene block of the styrene elastomer is favorably usable. Examples of the resin include an aliphatic hydrocarbon resin, a terpene resin, a coumarone-indene resin, an aromatic hydrocarbon resin and a rosin resin.

Additives such as a softener (e.g. liquid polymer and paraffin oil), a filler, a pigment, an antioxidant, a stabilizer and an ultraviolet absorber may be added to the adhesive layer as needed.

A ratio of the tackifier contained in the adhesive layer is favorably in a range of 1 part by mass to 8 parts by mass relative to 100 parts by mass of the vinyl-polyisoprene-block-containing styrene elastomer. When the tackifier content is less than 1 part by mass, the adhesive strength is weakened. For instance, the adhesive strength to an adherend having a projection is weakened, so that the adhesive layer may be peeled off. On the other hand, when the tackifier content exceeds 8 parts by weight, the adherend may be contaminated by bleed or cohesion force may be reduced. Also, since the adhesive strength between the adhesive layer and a smooth base material layer having a low outer haze (i.e., the rear surface of the rolled product) is increased, the unwinding property from the rolled product may be reduced.

In the surface protective film of the exemplary embodiment, the hardness (Martens hardness) of the adhesive layer is in a range of 1 N/mm² to 2.5 N/mm². When the hardness of the adhesive layer is less than 1 N/mm², since the hardness is too low, the adhesive strength of the adhesive layer to the rear surface of the base material layer is increased and thus the unwinding property from the rolled product may unfavorably be reduced. When the hardness of the adhesive layer exceeds 2.5 N/mm², since the hardness is too high, it becomes difficult for the adhesive layer to conform to an adherend having a projection, a sufficient adhesive strength cannot be obtained and thus the film may unfavorably be peeled off from the adherend.

The hardness of the adhesive layer is adjustable based on, for instance, the hardness of the vinyl-polyisoprene-block-containing styrene elastomer and the hardness of the polyolefin, which are contained in the adhesive layer. Further, when two or more polyolefins are contained, the hardness of the adhesive layer is also adjustable by the hardness of each polyolefin.

In the surface protective film of the exemplary embodiment, the loop tack strength of the adhesive layer (i.e., an adhering portion) is in a range of 0.02 N/25 mm to 0.1N/25 mm. When the loop tack strength is less than 0.02 N/25 mm, the adhesive force of the adhesive layer runs short and thus the film may be peeled off from an adherend. When the loop tack strength exceeds 0.1N/25 mm, the adhesive strength between the adhesive layer and the rear surface of the base material becomes too high and thus the unwinding property from the rolled product may unfavorably be reduced. The loop tack strength of the adhesive layer is adjustable, for instance, by the content of the tackifier to be contained in the adhesive layer.

The thickness of the adhesive layer is preferably 25 μm or less, more preferably in a range of 1 μm to 15 μm. Although the thickness of the adhesive layer does not necessarily have a lower limit, when the thickness is less than 1 μm, a tip ends of a projection of the adherend, if any, may be damaged. Also, the adhesive strength may be reduced and thus the film may be peeled off from the adherend. When the thickness of the adhesive layer exceeds 25 μm, the adhesive strength is too high and thus adhesive deposits may be left when the surface protective film is peeled off from the adherend. Also, since the adhesive strength to the rear surface of the base material layer is increased, the unwinding property from the rolled product may be reduced.

Accordingly, the thickness of the adhesive layer is preferably in a range of 1 μm to 15 μm.

In the surface protective film of the exemplary embodiment, the base material layer and the adhesive layer are preferably laminated by co-extrusion. According to co-extrusion, the base material layer and the adhesive layer can simultaneously be laminated without a solvent, thus producing a surface protective film by a relatively simple manufacturing device. Also, due to a simplified manufacturing process, manufacturing cost of the surface protective film can be reduced to a moderate level. Further, in a surface protective film manufactured by co-extrusion, interlaminar strength of a surface of the base material layer and the adhesive layer is high, and thus adhesive deposits are less possibly left when being peeled off from the adherend. The co-extrusion may be exemplified by a feed block method and a multi-manifold method.

The surface protective film of the exemplary embodiment is usable for protecting a surface of an adherend such as a metal plate, a glass plate and a synthetic-resin plate. Particularly, the surface protective film is preferably usable for a prism sheet having a projection on its surface, the projection having a substantially triangular cross section with an apex angle from 80 degrees to 100 degrees and a height from 20 μm to 80 μm.

According to the surface protective film of the exemplary embodiment, the adhesive layer has the hardness (Martens hardness) in a range of 1N/mm² to 2.5 N/mm² and loop tack strength in a range of 0.02 N/25 mm to 0.1N/25 mm. Accordingly, in the surface protective film in a form of a rolled product, without applying a particular mold releasing treatment to the base material layer, the surface protective film can be easily wound off from the rolled product while keeping a sufficient adhesive strength.

With this arrangement, efficiency in attachment of the surface protective film to the surface of the adherend can be enhanced. Also, it is less likely that the base material layer is partially stretched and deformed or the adhesive layer is partially peeled to spoil the surface protective film. Further, since the mold releasing treatment for obtaining the unwinding property from the rolled product is not required, manufacturing cost of the surface protective film can be reduced.

Furthermore, since there is no necessity to considerably roughen the rear surface of the base material, a highly transparent surface protective film can be provided.

It should be noted that the invention is not limited to the above exemplary embodiment but may include any modification and improvement as long as such modification and improvement are compatible with the invention.

Although the surface protective film exemplarily includes the base material layer and the adhesive layer in the exemplary embodiment, the surface protective film may include other functional layers such as an ultraviolet absorbing layer. In this arrangement, a surface of an adherend can be protected not only from physical contact but also from other factors such as ultraviolet rays.

The specific material, arrangement and the like described in carrying out the invention can be altered as long as an object of the invention can be achieved.

### EXAMPLES

Next, the invention will further be described in detail with reference to Examples and Comparatives. Note that the invention is not limited to the description of Examples.

### Example 1

Relative to 100 parts by mass of a vinyl-polyisoprene-block-containing styrene elastomer (manufactured by KURARAY CO., LTD., product name: HYBRAR 7125) which contains 20 mass % of styrene and 100 mass % of a triblock copolymer and has a glass transition temperature of −15 degrees C., 5 parts by mass of a polyolefin (RPP: manufactured by Japan Polypropylene Corporation, product name: WINTEC WFW-4) and 5 parts by mass of a tackifier (manufactured by Idemitsu Kosan Co., Ltd., product name: I-MARV P-140) were mixed to provide an adhesive layer. The adhesive layer and a polyolefin base material layer such as a BPP (polypropylene block copolymer) were co-extruded by double layer co-extrusion, specifically, by the feed block to provide a 11-μm thick adhesive layer and 39-μm thick base material layer. Thus, a surface protective film (hereinafter, simply referred to as “film”) was obtained.

Using PC-684S (MFR 5.0), PC-480A (MFR 2.0) and EP-310K (MFR 3.4) (manufactured by SunAllomer Ltd.) as BPP used for the base material layer, three kinds of films, each of which had a different base material layer, were obtained. The following Examples and Comparatives were conducted in the same manner.

### Example 2

Except for 3 parts by mass of the tackifier content in the adhesive layer, three kinds of films were obtained in the same manner as in Example 1.

### Example 3

Except for 7 parts by mass of the polyolefin content in the adhesive layer, three kinds of films were obtained in the same manner as in Example 1.

### Example 4

Except for 3 μm of the thickness of the adhesive layer, three kinds of films were obtained in the same manner as in Example 1.

### Comparative 1

Except for 15 parts by mass of the tackifier content in the adhesive layer, three kinds of films were obtained in the same manner as in Example 1.

### Comparative 2

Except for 10 parts by mass of the polyolefin content and 10 parts by mass of the tackifier content in the adhesive layer, three kinds of films were obtained in the same manner as in Example 1.

### Comparative 3

Except for 15 parts by mass of the polyolefin content and 15 parts by mass of the tackifier content in the adhesive layer, three kinds of films were obtained in the same manner as in Example 1.

### Comparative 4

Except for 20 parts by mass of the polyolefin content and 20 parts by mass of the tackifier content in the adhesive layer, three kinds of films were obtained in the same manner as in Example 1.

### Evaluation Method

Various properties of each film of Examples and Comparatives described above were evaluated according to the following method. Results are shown in Tables 1 and 2.

### (1) Hardness (Martens Hardness) of Adhesive Layer

Martens hardness was measured at a testing force of 1 mN and a load speed of 0.05 mN/sec using a dynamic ultramicro hardness tester (DHU-211 manufactured by Shimadzu Corporation).

### (2) Loop Tack Strength

Loop tack strength was measured using a vertical electric measuring stand (MV-500 NII-L550 manufactured by IMADA CO., LTD.) installed with a digital force gauge (ZP-5 N manufactured by IMADA CO., LTD.). Specifically, the measurement was conducted as follows.

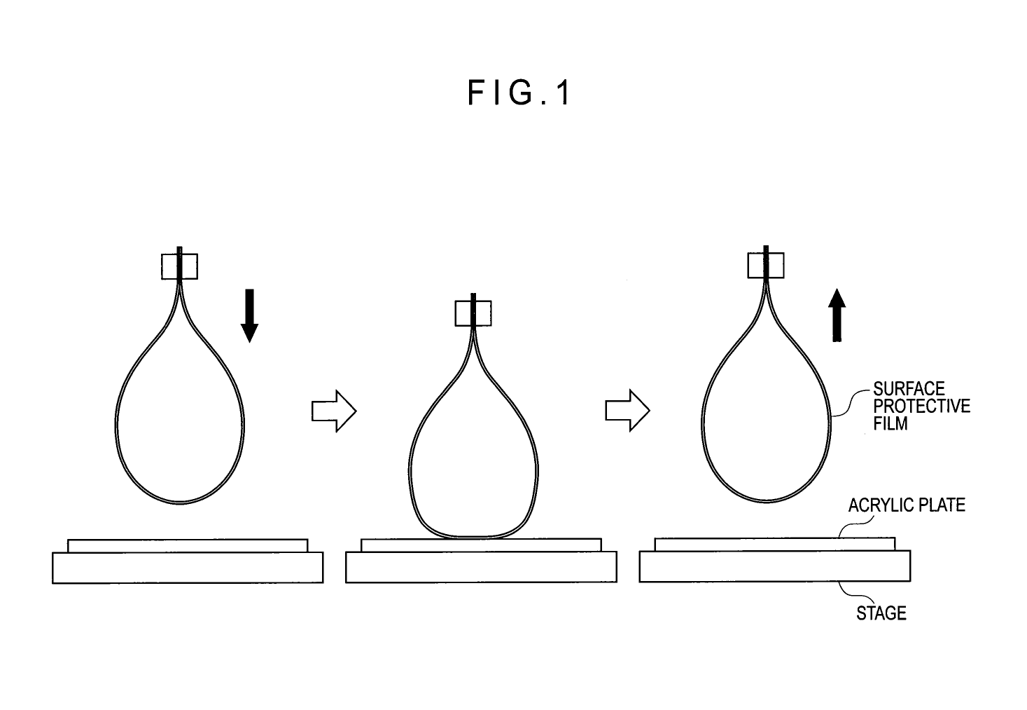

A film cut in 25-mm width and 300-mm length was fixed to a crosshead of the digital force gauge with an adhesive layer facing outward. The crosshead was lowered until a contact length of the film with an acrylic plate on a stage became 5 mm. After the crosshead was held for three seconds, a value of the digital force gauge was corrected to zero and the film was peeled off at a tensile speed of 0.3 m/min, where a resistance (N/25 mm) in the peeling was measured. FIG. 1 shows a schematic diagram of the test.

### (3) Adhesive Strength

The film was attached by pressure to an adherend (an acrylic resin-made prism sheet having a triangular cross section with an apex angle of about 90 degrees and a height of about 30 μm) under linear pressure of 0.38 MPa at 2 m/min and stored at 23 degrees C. for 24 hours. Then, the film was peeled off at a tensile speed of 0.3 m/min and 180 degrees peel using a tensile testing machine, and a resistance (N/25 mm) in the peeling was measured. In Table 1, the case where the measured resistance was 0.05 N/25 mm or more was represented by A, and the case where the measured resistance was less than 0.05 N/25 mm was represented by B.

### (4) Unwinding Strength

As for the three kinds of films, each of which had a different base material layer, an adhesive surface of the film and a rear surface of the base material layer were attached by pressure to each other under linear pressure of 0.38 MPa at 2 m/min and stored at 23 degrees C. for five minutes. Then, the film was peeled off at a tensile speed of 0.3 m/min and 90 degrees peel using the tensile testing machine, and a resistance (N/25 mm) in the peeling was measured. In Table 1, the case where the measured resistance was less than 0.2 N/25 mm was represented by A, and the case where the measured resistance was 0.2 N/25 mm or more was represented by B.

### (5) Haze

A total haze of the film was measured in accordance with JIS K 7105 using a haze meter (HZ-1 manufactured by Suga Test Instruments Co., Ltd.). An outer haze of the base material layer was obtained by the following method.

Only silicone oil (product name: SH200, manufactured by Dow Corning Toray Silicone Co., Ltd.) was fed between two glass plates, where haze was measured (Hz1). Next, a film having an adhesive layer surface coated with the silicone oil was interposed between the two glass plates, where haze was measured (Hz2). Subsequently, a film having both surfaces coated with the silicone oil was interposed between the two glass plates, where haze was measured (Hz3). An outer haze (Hz4) of the base material layer was calculated by the following formula.

Hz4=(Hz2−Hz1)−(Hz3−Hz1)

The case where the outer haze was 20% or less was represented by A, and the case where the outer haze exceeds 20% was represented by B.

TABLE 1

| | | | Example 1 | Example 2 | Example 3 | Example 4 |
|---|---|---|---|---|---|---|
| adhesive | styrene | styrene content (mass %) | 20 | 20 | 20 | 20 |
| layer | elastomer | triblock copolymer content | 100 | 100 | 100 | 100 |
| composition | | (mass %) | | | | |
| | | presence/absence of vinyl- | contained | contained | contained | contained |
| | | polyisoprene block | | | | |
| | | glass transition temperature | −15 | −15 | −15 | −15 |
| | | (° C.) | | | | |
| | | content (parts by mass) | 100 | 100 | 100 | 100 |

| | | | | |
|---|---|---|---|---|
| polyolefin content (parts by mass) | 5 | 5 | 7 | 5 |
| tackifier content (parts by mass) | 5 | 3 | 5 | 5 |

| thickness of adhesive layer (μn) | | 11 | | 11 | | 11 | | 3 | |
|---|---|---|---|---|---|---|---|---|---|
| hardness of adhesive layer (N/mm²) | | 1.7 | | 1.7 | | 1.8 | | 1.7 | |
| loop tack strength (N/25 mm) | | 0.06 | | 0.05 | | 0.06 | | 0.06 | |
| adhesive strength (N/25 mm) | | 0.08 | A | 0.07 | A | 0.07 | A | 0.06 | A |
| unwinding | base material layer: PC684A | 0.09 | A | 0.05 | A | 0.06 | A | 0.02 | A |
| strength | base material layer: PC480 | 0.15 | A | 0.08 | A | 0.07 | A | 0.03 | A |
| (N/25 mm) | base material layer: EP310K | 0.19 | A | 0.13 | A | 0.12 | A | 0.05 | A |

| | | | Comp. 1 | Comp. 2 | Comp. 3 | Comp. 4 |
|---|---|---|---|---|---|---|
| adhesive | styrene | styrene content (mass %) | 20 | 20 | 20 | 20 |
| layer | elastomer | triblock copolymer content | 100 | 100 | 100 | 100 |
| composition | | (mass %) | | | | |
| | | presence/absence of vinyl- | contained | contained | contained | contained |
| | | polyisoprene block | | | | |
| | | glass transition temperature | −15 | −15 | −15 | −15 |
| | | (° C.) | | | | |
| | | content (parts by mass) | 100 | 100 | 100 | 100 |

| | | | | |
|---|---|---|---|---|
| polyolefin content (parts by mass) | 5 | 10 | 15 | 20 |
| tackifier content (parts by mass) | 15 | 10 | 15 | 20 |

| thickness of adhesive layer (μn) | | 11 | | 11 | | 11 | | 11 | |
|---|---|---|---|---|---|---|---|---|---|
| hardness of adhesive layer (N/mm²) | | 1.7 | | 1.8 | | 2.3 | | 3.2 | |
| loop tack strength (N/25 mm) | | 0.15 | | 0.12 | | 0.13 | | 0.17 | |
| adhesive strength (N/25 mm) | | 0.09 | A | 0.06 | A | 0.06 | A | 0.04 | B |
| unwinding | base material layer: PC684A | 0.19 | A | 0.1 | A | 0.04 | A | 0.02 | A |
| strength | base material layer: PC480 | 0.28 | B | 0.18 | A | 0.13 | A | 0.07 | A |
| (N/25 mm) | base material layer: EP310K | 0.43 | B | 0.28 | B | 0.26 | B | 0.11 | A |

TABLE 2

| Haze (%) | |
|---|---|
| Total Haze | Outer Haze |

| | | | |
|---|---|---|---|
| PC684A | 50.1 | 44.3 | B |
| PC480 | 30.7 | 28.3 | B |
| EP310K | 8.4 | 7.3 | A |

### Evaluation Results

From the results shown in Table 1, it is found that each of the films of Examples can exhibit both a sufficient adhesive strength to a considerably rough surface such as a prism sheet and a favorable unwinding property since the hardness and the loop tack strength of the adhesive layer fall within a predetermined range.

Moreover, in comparison between Example 1 and Comparative 1, it is found that the adhesive strength of the adhesive layer to a considerably rough surface such as a prism sheet is dominated by Martens hardness of the adhesive layer and is not changed even when the tackifier content is increased to increase loop tack strength, whereas only the adhesive strength (i.e., unwinding strength) of the adhesive layer to the smoother rear surface of the base material layer than the prism sheet is increased.

It is found from Comparatives 2 and 3 that a favorable unwinding property cannot be obtained when loop tack strength exceeds 0.1N/25 mm even though Martens hardness of the adhesive layer falls within the range of 1N/25 mm² to 2.5 N/25 mm². In such a case, since it is necessary to considerably roughen the rear surface of the base material layer in order to improve the unwinding property, a transparent protective film cannot be obtained, which hinders a practical use of the film.

It is found from Comparative 4 that a sufficient adhesive strength cannot be obtained when Martens hardness exceeds 2.5 N/25 mm².

1. A surface protective film, comprising:
a polyolefin base material layer; and
an adhesive layer,
wherein the adhesive layer has hardness (Martens hardness) in a range of 1N/mm² to 2.5 N/mm² and loop tack strength in a range of 0.02 N/25 mm to 0.1N/25 mm.

2. The surface protective film according to claim 1, wherein the adhesive layer comprises:
a vinyl-polyisoprene-block-containing styrene elastomer;
a polyolefin; and
a tackifier.

3. The surface protective film according to claim 2, wherein the styrene elastomer has a styrene content in a range of 5 mass % to 30 mass %.

4. The surface protective film according to claim 2, wherein the styrene elastomer has a triblock copolymer content of 80 mass % or more.

5. The surface protective film according to claim 2, wherein the styrene elastomer has a glass transition temperature in a range of −60 degrees C. to 20 degrees C.

6. The surface protective film according to claim 1, wherein the adhesive layer has a thickness of 25 μm or less.

7. The surface protective film according to claim 1, wherein the base material layer has an outer haze of 20% or less.

8. The surface protective film according to claim 1, wherein the adhesive layer is laminated by co-extrusion.

9. The surface protective film according to claim 3, wherein the styrene elastomer has a triblock copolymer content of 80 mass % or more.

10. The surface protective film according to claim 3, wherein the styrene elastomer has a glass transition temperature in a range of −60 degrees C. to 20 degrees C.

11. The surface protective film according to claim 2, wherein the adhesive layer has a thickness of 25 μm or less.

12. The surface protective film according to claim 2, wherein the base material layer has an outer haze of 20% or less.

13. The surface protective film according to claim 2, wherein the adhesive layer is laminated by co-extrusion.
